(19) United States
(12) Patent Application Publication
(10) Pub. No.: US 2019/0246285 A1
(43) Pub. Date: Aug. 8, 2019

(54) WIRELESS COEXISTENCE INTERFACE SIGNALING IN A MULTIPLE-WWAN SCENARIO

(71) Applicant: QUALCOMM Incorporated, San Diego, CA (US)

(72) Inventors: Francis NGAI, Louisville, CO (US); Shriram GURUMOORTHY, Superior, CO (US); Olaf Josef HIRSCH, Sunnyvale, CA (US); Sridhar BANDARU, Westminster, CO (US); Helena Deirdre O'SHEA, San Diego, CA (US); Gary CHANG, San Jose, CA (US)

(21) Appl. No.: 16/263,833

(22) Filed: Jan. 31, 2019

Related U.S. Application Data
(60) Provisional application No. 62/625,959, filed on Feb. 2, 2018.
(60) Provisional application No. 62/631,420, filed on Feb. 15, 2018.

(51) Int. Cl. H04W 16/14; H04L 5/00; H04W 76/11; H04W 72/12; H04W 72/04

(52) U.S. Cl. CPC H04W 16/14; H04L 5/005; H04W 88/10; H04W 72/1215; H04W 72/0446; H04W 76/11

(57) ABSTRACT

A method, an apparatus, a transmitter component, and a computer program product for wireless communication are provided. The transmitter component may determine whether first information or second information is to be provided to a receiver component, wherein the first information includes a RAT identifier and the second information includes information regarding a transmit operation; and transmit a communication to the receiver component via a wireless coexistence interface between the receiver component and the transmitter component, wherein a particular portion of the communication is associated with a first value when the first information is to be provided, and wherein the particular portion is associated with a second value when the second information is to be provided. Numerous other aspects are provided.

### CROSS-REFERENCE TO RELATED APPLICATIONS UNDER 35 U.S.C. § 119

This application claims priority to U.S. Provisional Patent Application No. 62/625,959, filed on Feb. 2, 2018, entitled “TECHNIQUES AND APPARATUSES FOR WIRELESS COEXISTENCE INTERFACE SIGNALING IN A MULTIPLE-WWAN SCENARIO,” and U.S. Provisional Patent Application No. 62/631,420, filed on Feb. 15, 2018, entitled “TECHNIQUES AND APPARATUSES FOR WIRELESS COEXISTENCE INTERFACE SIGNALING IN A MULTIPLE-WWAN SCENARIO,” which are hereby expressly incorporated by reference herein.

### BACKGROUND

### Field

Aspects of the present disclosure generally relate to wireless communication, and more particularly to techniques and apparatuses for wireless coexistence interface (WCI) signaling in a multiple wireless wide area network (WWAN) scenario.

### Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless communication network may include a number of base stations (BSs) that can support communication for a number of user equipment (UEs). A UE may communicate with a BS via the downlink and uplink. The downlink (or forward link) refers to the communication link from the BS to the UE, and the uplink (or reverse link) refers to the communication link from the UE to the BS. As will be described in more detail herein, a base station (BS) may be referred to as a Node B, a gNB, an access point (AP), a radio head, a transmit receive point (TRP), a 5G BS, a 5G Node B, and/or the like.

The above multiple access technologies have been adopted in various telecommunication standards to provide a common protocol that enables different wireless communication devices to communicate on a municipal, national, regional, and even global level. 5G, which may also be referred to as New Radio (NR), is a set of enhancements to the LTE mobile standard promulgated by the Third Generation Partnership Project (3GPP). 5G is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE and 5G technologies. Preferably, these improvements should be applicable to other multiple access technologies and the telecommunication standards that employ these technologies.

A UE may communicate using a variety of radio access technologies (RATs). A RAT may include a wireless local area network (WLAN) RAT (e.g., Bluetooth, 2.4 GHz WiFi, 5 GHz WiFi, 6 GHz WiFi, 60 GHz 11ad, etc.) or a wireless wide area network (WWAN) RAT (e.g., 4G, 5G/NR, Licensed LTE, License-assisted Access (LAA), enhanced LAA (eLAA), etc.). In some cases, a UE may support multiple RATs, such as a WLAN RAT and a WWAN RAT.

### SUMMARY

The usage of multiple RATs may create coexistence issues, such as desense, overlapping transmissions or receptions, and/or the like. The Wireless Coexistence Interface 2 (WCI-2) standard may define a framework for communication between components of a UE that supports the use of a WWAN RAT and a WLAN RAT. For example, WCI-2 may provide a mechanism to facilitate mitigation of coexistence issues by exchanging messages (e.g., real-time messages, data plane messages, etc.) between the components. However, difficulties may arise when a UE supports multiple WLAN RATs and/or multiple WWAN RATs. For example, a component of the UE that receives a WCI message regarding a particular RAT may not know a RAT identifier of the particular RAT, so configuration information associated with the particular RAT may not be comprehensible or useful for the component.

Some techniques and apparatuses described herein provide a RAT identifier with a WCI message so that a receiver component of a UE can determine the RAT identifier associated with the WCI message. Additionally, or alternatively, some techniques and apparatuses described herein provide a transmit message using the WCI message (e.g., a different bit value of the WCI message than used to indicate the RAT identifier), which allows for a transmit operation to be performed by the receiver component. In some aspects, a particular WCI message format corresponding to a particular vendor configuration of the receiver component may be used. For example, the particular WCI message may be formatted according to a message type defined by the particular vendor configuration (e.g., a WCI Type-7 message and/or the like), which may improve efficiency of provision of the RAT identifier. In some aspects, the message type may be one that is agreed to by multiple different vendors (e.g., a WCI Type-2 or Type-5 message and/or the like), which improves interoperability of the transmitter component and the receiver component.

In an aspect of the disclosure, a method, a transmitter component, an apparatus, a system, and a computer program product are provided.

In some aspects, the method may be performed by the transmitter component. The method may include determining whether first information or second information is to be provided to a receiver component, wherein the first information includes a RAT identifier and the second information includes information regarding a transmit operation; and transmitting a communication to the receiver component via a wireless coexistence interface between the receiver component and the transmitter component, wherein a particular portion of the communication is associated with a first value when the first information is to be provided, and wherein the particular portion is associated with a second value when the second information is to be provided.

In some aspects, the transmitter component may include a memory and one or more processors operatively coupled to the memory. The memory and the one or more processors may be configured to determine whether first information or second information is to be provided to a receiver component, wherein the first information includes a RAT identifier and the second information includes information regarding a transmit operation; and transmit a communication to the receiver component via a wireless coexistence interface between the receiver component and the transmitter component, wherein a particular portion of the communication is associated with a first value when the first information is to be provided, and wherein the particular portion is associated with a second value when the second information is to be provided.

In some aspects, the apparatus may include means for determining whether first information or second information is to be provided to a receiver component, wherein the first information includes a RAT identifier and the second information includes information regarding a transmit operation; and means for transmitting a communication to the receiver component via a wireless coexistence interface between the receiver component and the apparatus, wherein a particular portion of the communication is associated with a first value when the first information is to be provided, and wherein the particular portion is associated with a second value when the second information is to be provided.

In some aspects, the computer program product may include a non-transitory computer-readable medium storing one or more instructions. The one or more instructions, when executed by one or more processors of a transmitter component, may cause the one or more processors to determine whether first information or second information is to be provided to a receiver component, wherein the first information includes a RAT identifier and the second information includes information regarding a transmit operation; and transmit a communication to the receiver component via a wireless coexistence interface between the receiver component and the transmitter component, wherein a particular portion of the communication is associated with a first value when the first information is to be provided, and wherein the particular portion is associated with a second value when the second information is to be provided.

The system may include at least one transmitter component; at least one receiver component; and a plurality of wireless coexistence interfaces between the at least one transmitter component and the at least one receiver component, the at least one transmitter component to: determine whether first information or second information is to be provided to the at least one receiver component, wherein the first information includes a RAT identifier and the second information includes information regarding a transmit operation; and transmit a communication to the at least one receiver component via a particular wireless coexistence interface of the plurality of wireless coexistence interfaces, wherein a particular portion of the communication is associated with a first value when the first information is to be provided, and wherein the particular portion is associated with a second value when the second information is to be provided.

Aspects generally include a method, apparatus, system, computer program product, non-transitory computer-readable medium, user equipment, base station, wireless communication device, receiver component, transmitter component, and processing system as substantially described herein with reference to and as illustrated by the accompanying drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

FIG. 1 is diagram illustrating an example of a wireless communication network.

FIG. 2 is a diagram illustrating an example of a base station in communication with a user equipment (UE) in a wireless communication network.

FIG. 3 is a diagram illustrating example components of a UE configured to use WCI messaging.

FIG. 4 is a diagram illustrating example modules of a UE configured to use WCI messaging.

FIGS. 5A and 5B are diagrams illustrating examples of components or modules of a UE configured to use WCI messaging.

FIG. 6 is a diagram illustrating an example of a format for a WCI message.

FIG. 7 is a diagram illustrating an example of performing WCI messaging in a multiple-WWAN scenario.

FIG. 8 is a diagram illustrating an example of a format for a WCI message that indicates a RAT identifier or a transmit operation.

FIGS. 9A and 9B are diagrams illustrating examples of formats for a WCI message including configuration information associated with a particular RAT.

FIG. 10 is a flow chart of a method of communication.

FIG. 11 is a flow chart of another method of communication.

FIG. 12 is a diagram illustrating an example of a low noise amplifier (LNA) blanking configuration.

FIG. 13 is a diagram illustrating an example of a command format for a command associated with a WCI-2 message.

FIGS. 14A and 14B are diagrams illustrating flow charts of methods associated with signaling for wakeup or sleep of a client, such as a client described herein.

### DETAILED DESCRIPTION

The detailed description set forth below in connection with the appended drawings is intended as a description of various configurations and is not intended to represent the configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, and/or the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, and/or the like, whether referred to as software, firmware, middleware, microcode, hardware description language, or otherwise.

Accordingly, in one or more example embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, combinations of the aforementioned types of computer-readable media, or any other medium that can be used to store computer executable code in the form of instructions or data structures that can be accessed by a computer.

It should be noted that while aspects may be described herein using terminology commonly associated with 3G and/or 4G wireless technologies, aspects of the present disclosure can be applied in other generation-based communication systems, such as 5G and later, including 5G technologies.

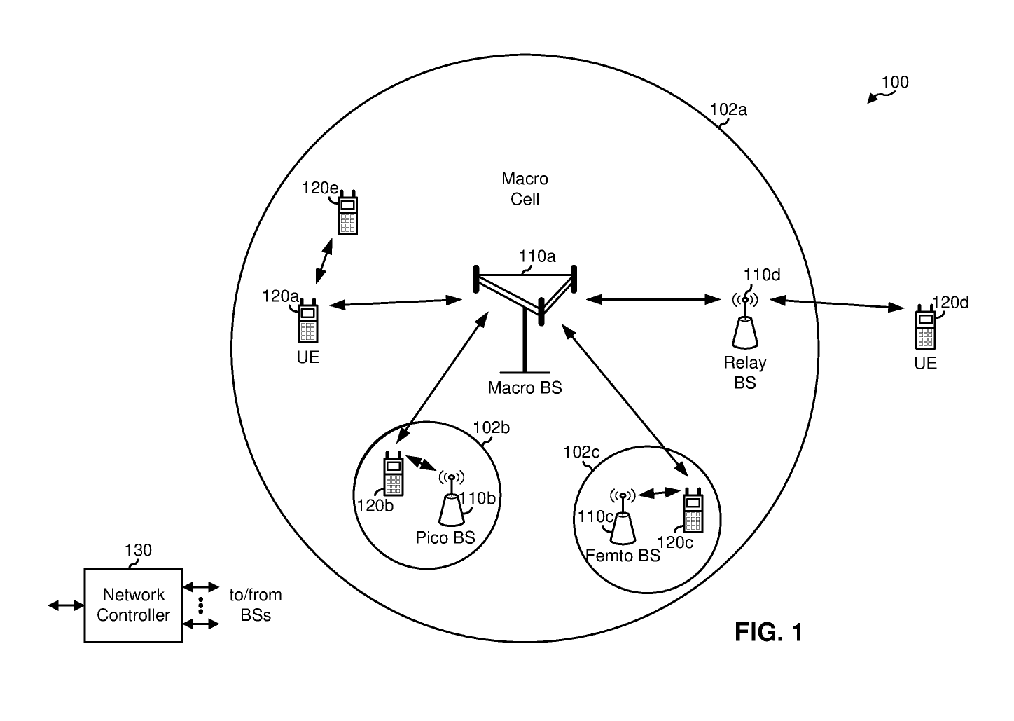

FIG. 1 is a diagram illustrating a network 100 in which aspects of the present disclosure may be practiced. The network 100 may be an LTE network or some other wireless network, such as a 5G network. Wireless network 100 may include a number of BSs 110 (shown as BS 110a, BS 110b, BS 110c, and BS 110d) and other network entities. A BS is an entity that communicates with user equipment (UEs) and may also be referred to as a base station, a 5G BS, a Node B, a gNB, a 5G NB, an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “5G BS”, “gNB”, “TRP”, “AP”, “node B”, “5G NB”, and “cell” may be used interchangeably herein.

In some examples, a cell may not necessarily be stationary, and the geographic area of the cell may move according to the location of a mobile BS. In some examples, the BSs may be interconnected to one another and/or to one or more other BSs or network nodes (not shown) in the access network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communication between BS 110a and UE 120d. A relay station may also be referred to as a relay BS, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 Watts) whereas pico BSs, femto BSs, and relay BSs may have lower transmit power levels (e.g., 0.1 to 2 Watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, etc. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

In general, any number of wireless networks may be deployed in a given geographic area. Each wireless network may support a particular RAT and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, 5G RAT networks may be deployed. A wireless network may be a WWAN (e.g., 4G/LTE, LAA, eLAA, 5G/NR, etc.) or a WLAN (e.g., Bluetooth, WiFi, etc.).

In some examples, access to the air interface may be scheduled, wherein a scheduling entity (e.g., a base station) allocates resources for communication among some or all devices and equipment within the scheduling entity's service area or cell. Within the present disclosure, as discussed further below, the scheduling entity may be responsible for scheduling, assigning, reconfiguring, and releasing resources for one or more subordinate entities. That is, for scheduled communication, subordinate entities utilize resources allocated by the scheduling entity.

Base stations are not the only entities that may function as a scheduling entity. That is, in some examples, a UE may function as a scheduling entity, scheduling resources for one or more subordinate entities (e.g., one or more other UEs). In this example, the UE is functioning as a scheduling entity, and other UEs utilize resources scheduled by the UE for wireless communication. A UE may function as a scheduling entity in a peer-to-peer (P2P) network, and/or in a mesh network. In a mesh network example, UEs may optionally communicate directly with one another in addition to communicating with the scheduling entity.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

Thus, in a wireless communication network with a scheduled access to time-frequency resources and having a cellular configuration, a P2P configuration, and a mesh configuration, a scheduling entity and one or more subordinate entities may communicate utilizing the scheduled resources.

As indicated above, FIG. 1 is provided merely as an example. Other examples may differ from what is described with regard to FIG. 1.

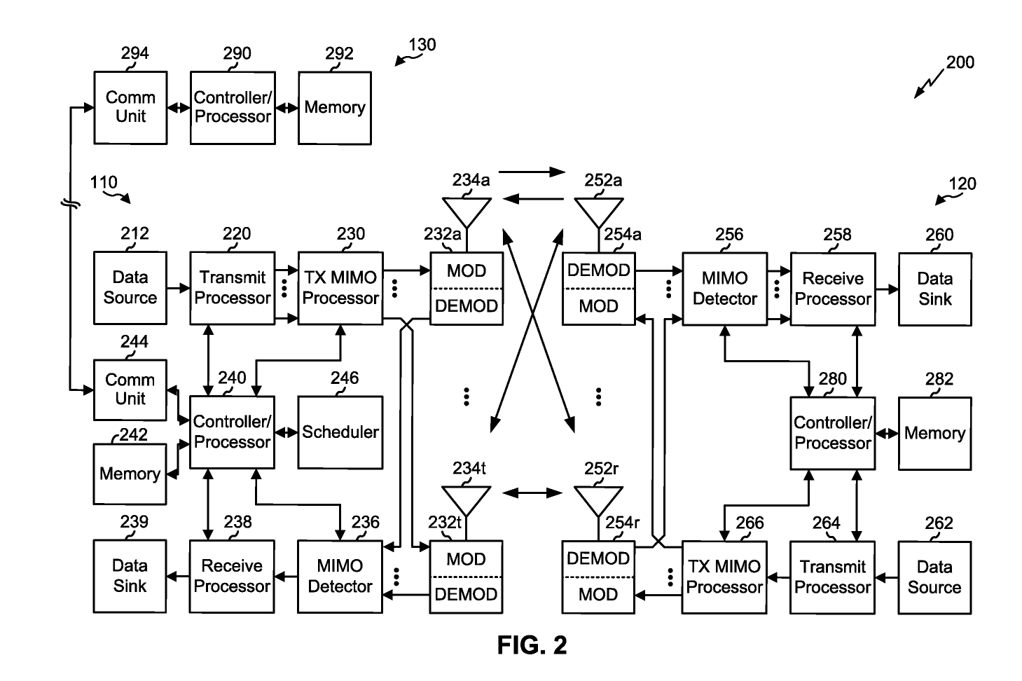

FIG. 2 shows a block diagram 200 of a design of BS 110 and UE 120, which may be one of the base stations and one of the UEs in FIG. 1. BS 110 may be equipped with T antennas 234a through 234t, and UE 120 may be equipped with R antennas 252a through 252r, where in general T≥1 and R≥1.

At BS 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI), and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At UE 120, antennas 252a through 252r may receive the downlink signals from BS 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive (RX) processor 258 may process (e.g., demodulate and decode) the detected symbols, provide decoded data for UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 120, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to BS 110. At BS 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. BS 110 may include communication unit 244 and communicate to network controller 130 via communication unit 244. Network controller 130 may include communication unit 294, controller/processor 290, and memory 292.

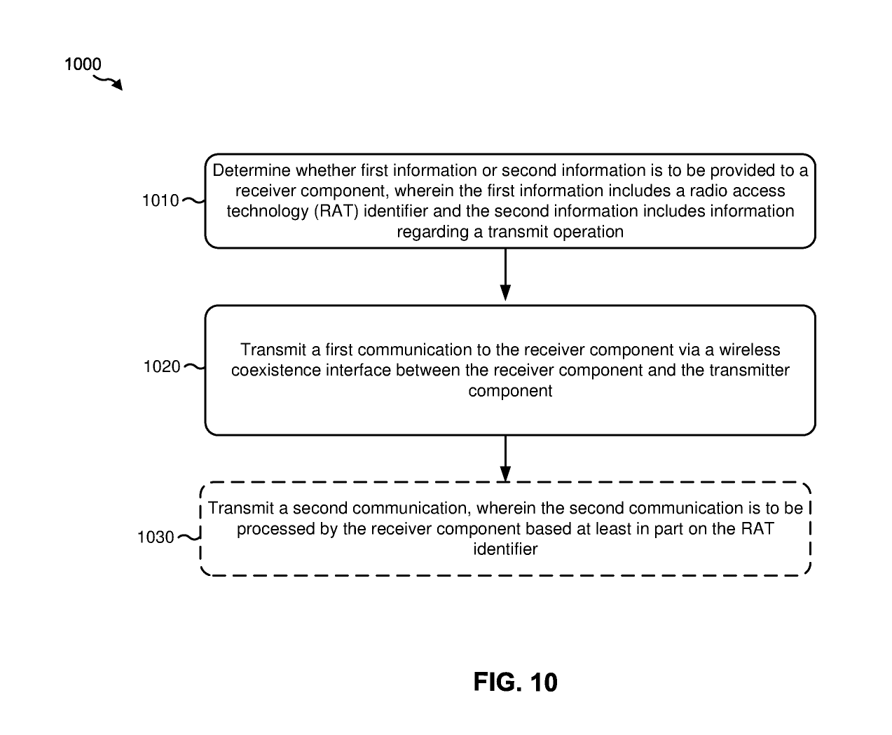

Controller/processor 240 of BS 110, controller/processor 280 of UE 120, and/or any other component(s) of FIG. 2 may perform one or more techniques associated with WCI signaling in a multiple-WWAN scenario, as described in more detail elsewhere herein. For example, controller/processor 240 of BS 110, controller/processor 280 of UE 120, and/or any other component(s) of FIG. 2 may perform or direct operations of, for example, method 1000 of FIG. 10 and/or other processes as described herein. Memories 242 and 282 may store data and program codes for BS 110 and UE 120, respectively. A scheduler 246 may schedule UEs for data transmission on the downlink and/or uplink.

As indicated above, FIG. 2 is provided merely as an example. Other examples may differ from what is described with regard to FIG. 2.

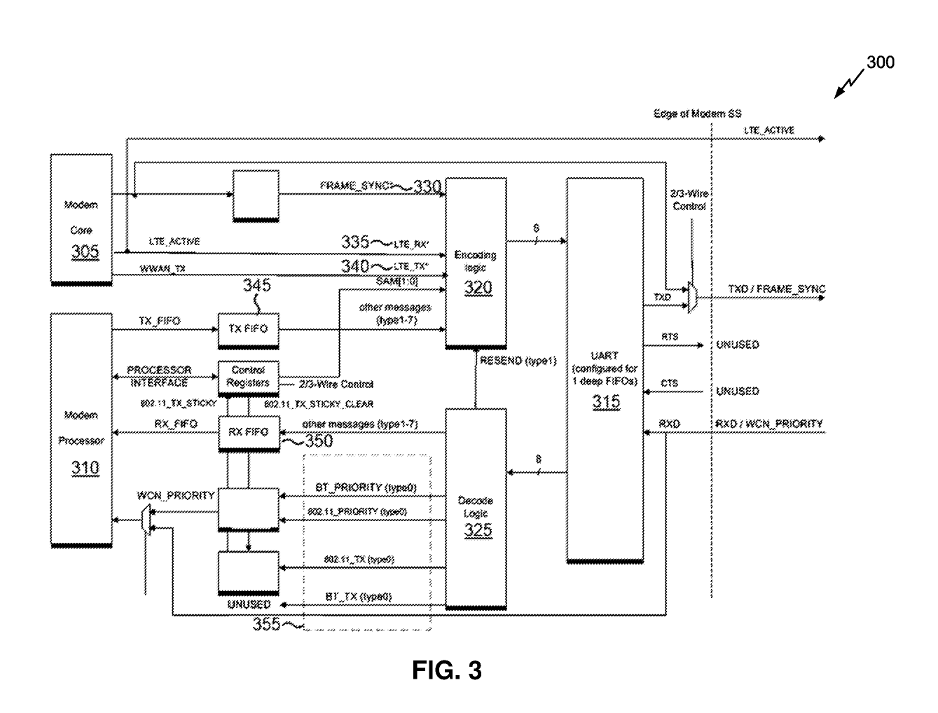

FIG. 3 is a diagram illustrating example components of a WWAN modem 300 of a UE (e.g., UE 120) configured to use WCI messaging. As shown, WWAN modem 300 may include a modem core 305 and a modem processor 310. Modem core 305 may determine and/or provide frame synchronization information, transmitted LTE signals, and/or received LTE signals. Modem processor 310 may perform processing related to operation of WWAN modem 300. In some aspects, modem core 305 and/or modem processor 310 may provide signals to and/or receive signals from a universal asynchronous receiver/transmitter (UART) 315 of WWAN modem 300. In some aspects, modem core 305, modem processor 310, and/or UART 315 may be produced by, provided by, and/or implemented by different vendors (e.g., different service providers, different component manufacturers, different component suppliers, and/or the like).

As further shown, WWAN modem 300 may include encoding logic 320 and decoding logic 325. Encoding logic 320 may include a component or module that performs encoding of signals en route to UART 315 from modem core 305 and/or modem processor 310. Decoding logic 325 may include a component or module that performs decoding of signals en route from UART 315 to modem core 305 and/or modem processor 310.

In some aspects, modem core 305 may determine and/or provide frame synchronization information, shown by reference number 330. For example, a rising edge detection component of modem WWAN 300 may determine a rising edge associated with a synchronization signal and may provide frame synchronization information based at least in part on the synchronization signal.

As shown by reference number 335, modem core 305 may provide LTE reception information for provision by UART 315 (e.g., to another module or component of UE 120). As shown by reference number 340, modem core 305 may provide LTE transmission information for provision by UART 315 (e.g., to another module or component of UE 120).

As shown by reference number 345, modem processor 310 may provide transmit first-in first-out (TX FIFO) information to a TX FIFO component 345. The TX FIFO component 345 may store or buffer data to be transmitted or provided by UART 315 based at least in part on the FIFO approach. As shown by reference number 350, UART 315 may provide receive first-in first-out (RX FIFO) information to a RX FIFO component 350. The RX FIFO component 350 may store or buffer data to be provided to modem processor 310 based at least in part on the FIFO approach. As further shown, in some aspects, the transmit FIFO information and/or the receive FIFO information may include one or more WCI messages, which are described in more detail elsewhere herein.

As shown by reference number 355, in some aspects, modem processor 310 may receive real-time information from UART 315. For example, the real-time information may be provided in a real-time WCI message, such as a WCI-2 Type-0 message. In some aspects, the real-time information may include Bluetooth priority information, WiFi priority information (shown as 802.11_PRIORITY), information received on a WiFi RAT (shown as 802.11_TX), and/or information received on a Bluetooth RAT (shown as BT_TX).

In some aspects, UE 120 may include a single WWAN modem 300 associated with multiple WWAN RATs. For example, WWAN modem 300 may be configured to communicate using two or more of a 4G/LTE RAT, a 5G/NR RAT, an LAA RAT, an eLAA RAT, and/or another WWAN RAT. In some aspects, UE 120 may include multiple, different WWAN modems 300. For example, each WWAN RAT used by UE 120 may be associated with a respective WWAN modem 300.

As indicated above, FIG. 3 is provided merely as an example. Other examples may differ from what is described with regard to FIG. 3.

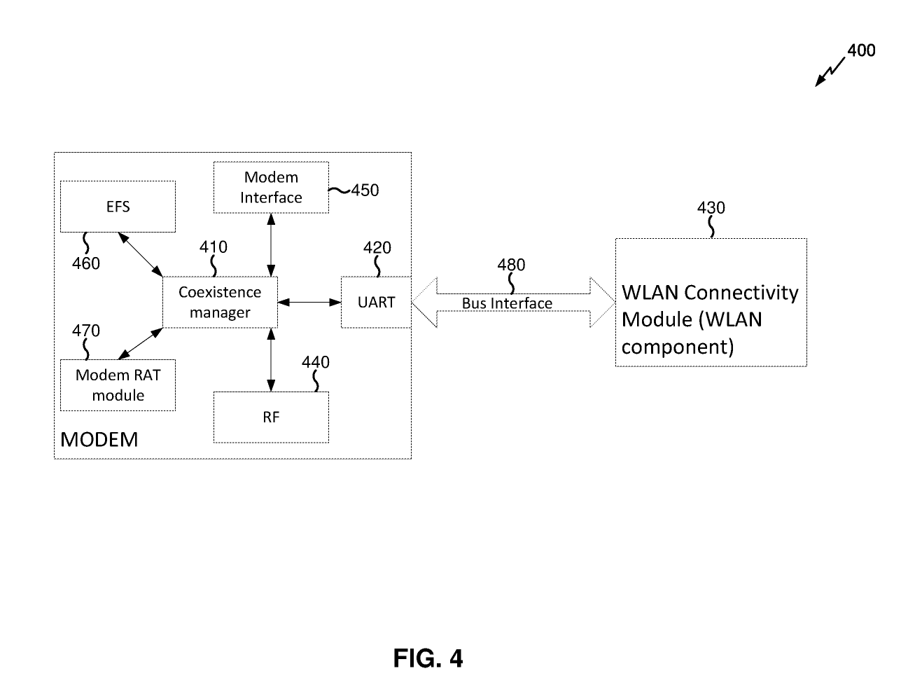

FIG. 4 is a diagram illustrating example modules of a system 400 of a UE configured to use WCI messaging. As shown, system 400 may include a modem, such as a WWAN modem associated with 4G/LTE, 5G/NR, and/or the like. The modem may include a coexistence manager 410. The coexistence manager 410 may perform tasks associated with coexistence of multiple RATs (e.g., WLAN and WWAN RATs). As further shown, the modem may include a UART module 420 (e.g., a software and/or firmware module) to perform functions associated with UART 315 of FIG. 3. As shown, UART module 420 may communicate with a WLAN connectivity module 430, which may include a WLAN chip or a WLAN chipset of UE 120. In some aspects, the modem may include 1, 2, or more WLAN components, WLAN chips, or WLAN solutions.

As further shown, the modem may include an RF module 440, which may perform processing or tasks related to RF communication of system 400 (e.g., 4G/LTE communication, 5G/NR communication, etc.). As further shown, system 400 may include a modem interface 450, which may communicate with an access point (AP) external to system 400. For example, the AP may include BS 110 associated with a WLAN and/or the like.

As shown, system 400 may include an extended file system (EFS) 460. EFS 460 may include a non-transitory computer-readable medium. EFS 460 may store configuration information for system 400. In some aspects, EFS 460 may store coexistence configuration information. As shown, system 400 may include a modem RAT module 470, which may perform functions relating to a particular RAT (e.g., 4G/LTE, 5G/NR, etc.). As further shown, system 400 may include a bus interface 480 between the modem and the WLAN connectivity module.

As indicated above, FIG. 4 is provided merely as an example. Other examples may differ from what is described with regard to FIG. 4.

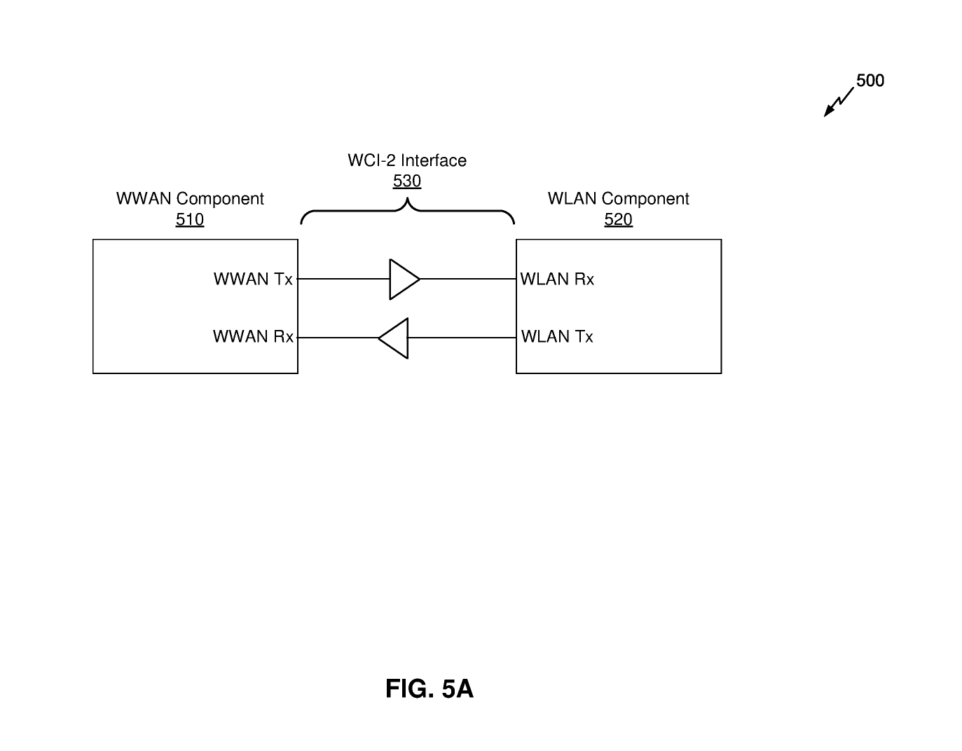

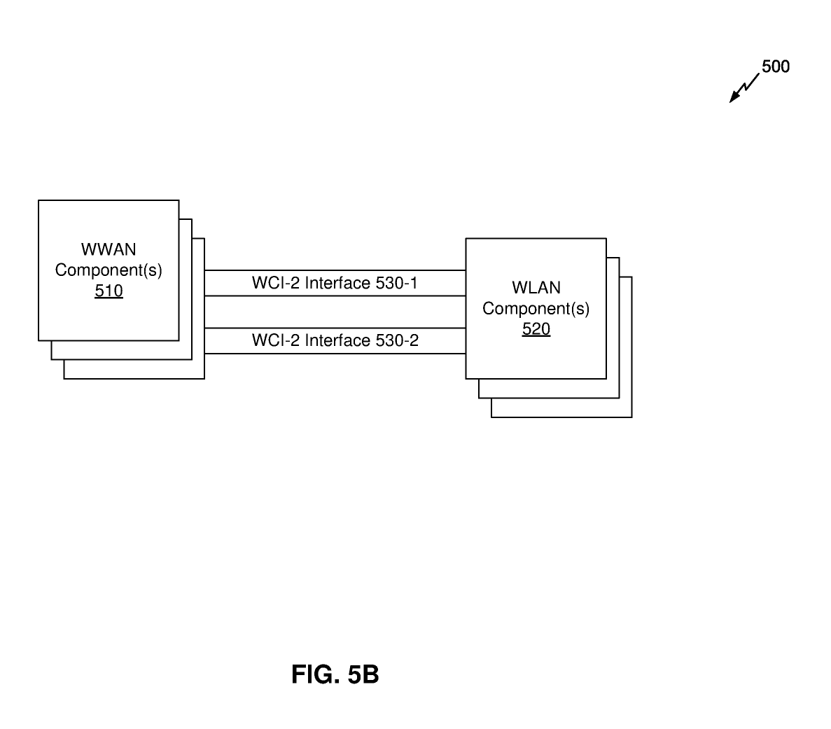

FIGS. 5A and 5B are diagrams illustrating examples 500 of components or modules of a UE configured to use WCI messaging. As shown, a UE (e.g., UE 120) may include a WWAN component 510 and a WLAN component 520. WWAN component 510 may include a WWAN modem, such as modem 300, the modem shown in FIG. 4, MOD/DEMOD 232, and/or the like. WLAN component 520 may include a WLAN chipset, a WLAN card, a WLAN chip, a WLAN modem, and/or the like, such as WLAN connectivity module 430 shown in FIG. 4. As further shown, WWAN component 510 and WLAN component 520 may be associated with an interface, such as a WCI-2 interface 530. The WCI-2 interface 530 may carry WCI messages between WWAN component 510 and WLAN component 520. In some aspects, the WCI-2 interface 530 may be implemented on the bus interface 480 shown in FIG. 4.

The techniques and apparatuses described herein are described with reference to a transmitter component and a receiver component. As shown, in some aspects, WWAN component 510 may be a transmitter component and WLAN component 520 may be a receiver component. For example, WWAN component 510 may transmit one or more WCI messages to WLAN component 520. As further shown, in some aspects, WLAN component 520 may be a transmitter component and WWAN component 510 may be a receiver component. For example, WLAN component 520 may transmit one or more WCI messages to WWAN component 510.

As shown in FIG. 5B, in some aspects, UE 120 may be associated with multiple, different WWAN components 510, WLAN components 520, and/or WCI-2 interfaces 530. For example, UE 120 may be associated with a plurality of WWAN components 510 and a corresponding plurality of WCI-2 interfaces 530. In some aspects, each WCI-2 interface 530 may be associated with at least one of a respective RAT, a respective WWAN component 510, and/or a respective WLAN component(s) 520. In some aspects, a single WCI-2 interface 530 may be used wherein all WLAN components are integrated into a single chip.

In some aspects, WWAN component 510 and/or WLAN component 520, as a transmitter component, may include means for determining whether first information or second information is to be provided to a receiver component, wherein the first information includes a RAT identifier and the second information includes information regarding a transmit operation; means for transmitting a communication to the receiver component via a wireless coexistence interface between the receiver component and the transmitter component; means for transmitting a transmission advance notification; means for transmitting a second communication, wherein the second communication is to be processed by the receiver component based at least in part on the RAT identifier; and/or the like. In some aspects, such means may include one or more components of UE 120 described in connection with FIGS. 2-4.

As indicated above, FIGS. 5A and 5B are provided merely as examples. Other examples may differ from what is described with regard to FIGS. 5A and 5B.

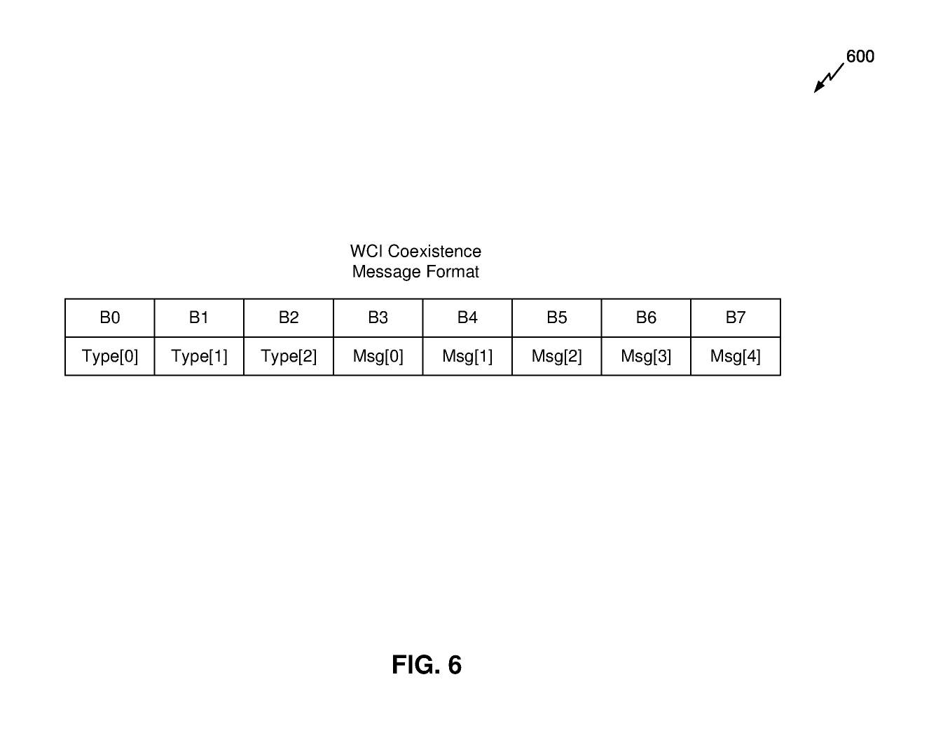

FIG. 6 is a diagram illustrating an example 600 of a format for a WCI message, such as a WCI coexistence message as defined by WCI-2. As shown, a WCI message may include 8 bits (e.g., 1 byte). A first portion (e.g., 3 bits) of the WCI message (e.g., B0, B1, and B2) may be used to identify a message type of the WCI message (e.g., Type-0 through Type-7). As further shown, a second portion (e.g., 5 bits) of the WCI message, (e.g., B3, B4, B5, B6, and B7) may carry a message of the WCI message. The content of the message may depend on the message type and/or other information associated with the WCI message, such as a RAT identifier, a transmit message with information regarding a transmit operation, and/or the like, as described in more detail elsewhere herein.

In some aspects, the message may be a Type-0 message. A Type-0 message may include a real-time signaling message that carries real-time information, such as frame synchronization information, a transmit message with information regarding a transmit operation, a Bluetooth transmit state, a Mobile Wireless Standard (MWS) pattern, an MWS transmit state, a WiFi transmit state, an inactivity duration, a scan frequency, and/or the like.

In some aspects, the message may be a Type-1 message. A Type-1 message may carry transport control information. In some aspects, UE 120 (e.g., a receiver component) may retransmit a Type-0 message based at least in part on receiving a Type-1 message.

In some aspects, the message may be a Type-2 message. A Type-2 message may carry transport data. In some aspects, a Type-2 message may have a vendor-specific format. In some aspects, a Type-2 message may include a RAT identifier, a transmit message with information regarding a transmit operation, and/or the like, as described in more detail elsewhere herein.

In some aspects, the message may be a Type-3 message. A Type-3 message, when transmitted from WWAN component 510 to WLAN component 520, may identify a modem inactivity duration. The Type-3 message, when transmitted from WLAN component 520 to WWAN component 510, may be reserved for future use. As used herein, a message format that is reserved for future use may refer to a message format that is not specified by the WCI-2 standard, so that a vendor can implement a vendor-specific message format for the corresponding message. When a transmitter component and a receiver component are implemented by or associated with different vendors, the use of a message format that is reserved for future use may enable intercommunication between the transmitter component and the receiver component. For example, the different vendors may agree on a message format that is to be operable for the transmitter component and the receiver component. Examples of such a message format include the transmit message and the message including the RAT identifier, as described in more detail elsewhere herein.

In some aspects, the message may be a Type-4 message. A Type-4 message, when transmitted from WWAN component 510 to WLAN component 520, may identify an MWS scan frequency. The Type-4 message, when transmitted from WLAN component 520 to WWAN component 510, may be reserved for future use.

In some aspects, the message may be a Type-5 message. A Type-5 message may be reserved for future use. In some aspects, a Type-5 message may include a RAT identifier, a transmit message, and/or the like, as described in more detail elsewhere herein.

In some aspects, the message may be a Type-6 message. In some aspects, a Type-6 message may have a vendor-specific format. In some aspects, a Type-6 message, when transmitted from WWAN component 510 to WLAN component 520, may identify a transmit advanced notice for a WWAN RAT. The Type-6 message, when transmitted from WLAN component 520 to WWAN component 510, may be reserved for future use or may have a vendor-specific format.

In some aspects, the message may be a Type-7 message. The Type-7 message may have a vendor-specific format. Some vendors may use a Type-7 message to provide information regarding a RAT (e.g., a WWAN RAT and/or a WLAN RAT). For example, the Type-7 message may indicate a radio resource control (RRC) connection state, may indicate whether transmission power of the RAT satisfies a threshold, may indicate a transmission antenna identifier associated with the RAT, and/or the like. In some aspects, a Type-7 message may include a RAT identifier, a transmit message, and/or the like, as described in more detail elsewhere herein.

These message uses are examples only, and can be modified for new purposes as solutions adapt. The messages may not strictly adhere to WCI-2 protocol constraints over UART, and may be modified for transmission over a non-UART bus, such as a bus shown by reference number 480.

As indicated above, FIG. 6 is provided merely as an example. Other examples may differ from what is described with regard to FIG. 6.

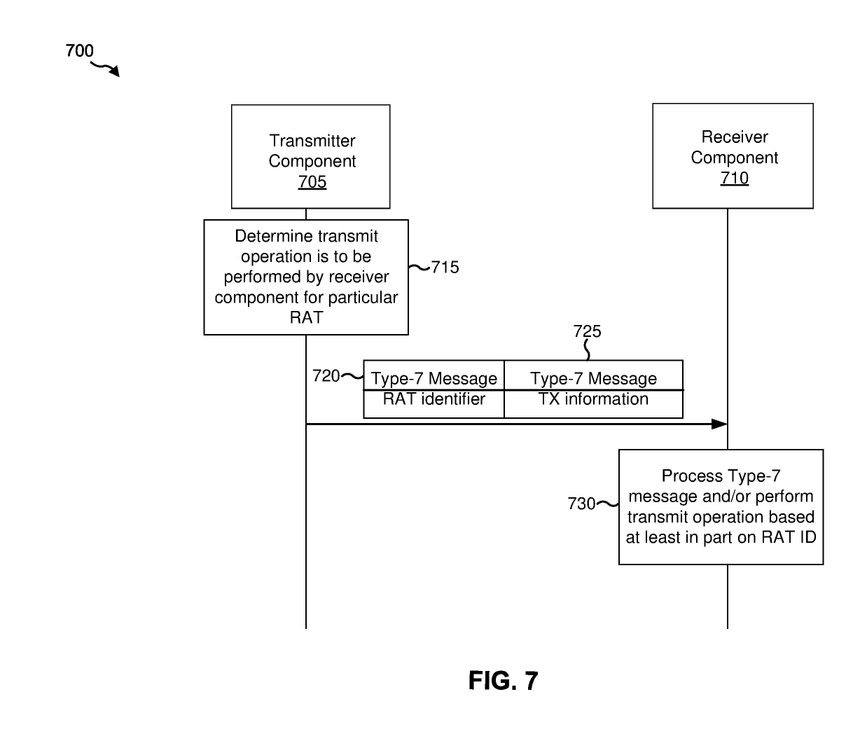

FIG. 7 is a diagram illustrating an example of performing WCI messaging in a multiple-WWAN scenario. As shown, FIG. 7 includes a transmitter component 705 and a receiver component 710. Transmitter component 705 may include WWAN component 510 and/or WLAN component 520. Receiver component 710 may include WWAN component 510 and/or WLAN component 520. In other words, the messaging described in connection with FIG. 7 may be performed from WWAN component 510 to WLAN component 520 or from WLAN component 520 to WWAN component 510. In some aspects, transmitter component 705 and receiver component 710 may be associated with a same vendor, such as a same manufacturer, a same service provider, a same supplier, and/or the like. In some aspects, transmitter component 705 and receiver component 710 may be associated with different vendors, such as different manufacturers, service providers, suppliers, and/or the like.

As shown by reference number 715, the transmitter component 705 may determine that a transmit operation is to be performed by the receiver component 710. For example, in a transmit operation, the receiver component 710 may cease transmission for a particular RAT, or may cease transmission for all RATs associated with the receiver component 710. This may be useful to reduce interference or desense associated with the transmitter component 705 (e.g., for ultra-reliable traffic and/or the like).

In some aspects, the transmitter component 705 may determine information regarding a particular RAT to provide to the receiver component 710. For example, the information regarding the particular RAT may include any information relevant to the particular RAT, such as information indicating whether a transmission power of the particular RAT satisfies a threshold, an antenna identifier associated with the particular RAT, frame synchronization information, reception information, transmission information, information for a custom field (e.g., information indicating a mitigation action for the receiver component 710 based at least in part on a transmission power of the particular RAT), information indicating a high-gain/bypass (HG/BP) state to be used by the receiver component 710, and/or other information.

As shown by reference number 720, the transmitter component 705 may provide a Type-7 message to the receiver component 710. As further shown, the Type-7 message may include a RAT identifier. The RAT identifier may correspond to the particular RAT. For example, transmitter component 705 may store or have access to information identifying RAT identifiers and corresponding RATs. In some aspects, the Type-7 message may be used because the transmitter component 705 and the receiver component 710 may be implemented by or provided by a same vendor, so the Type-7 message may be unlikely to be reserved for another purpose.

In some aspects, a Type-5 message may be used. For example, the Type-5 message may be reserved for future use. This may mean that the Type-5 message can be used to provide the RAT identifier irrespective of whether transmitter component 705 and receiver component 710 are associated with the same vendor or different vendors, thus improving uniformity of configuration and efficiency of interoperation of transmitter component 705 and receiver component 710. In some aspects, the RAT identifier may be provided in a message of a different format (e.g., Type-2, etc.).

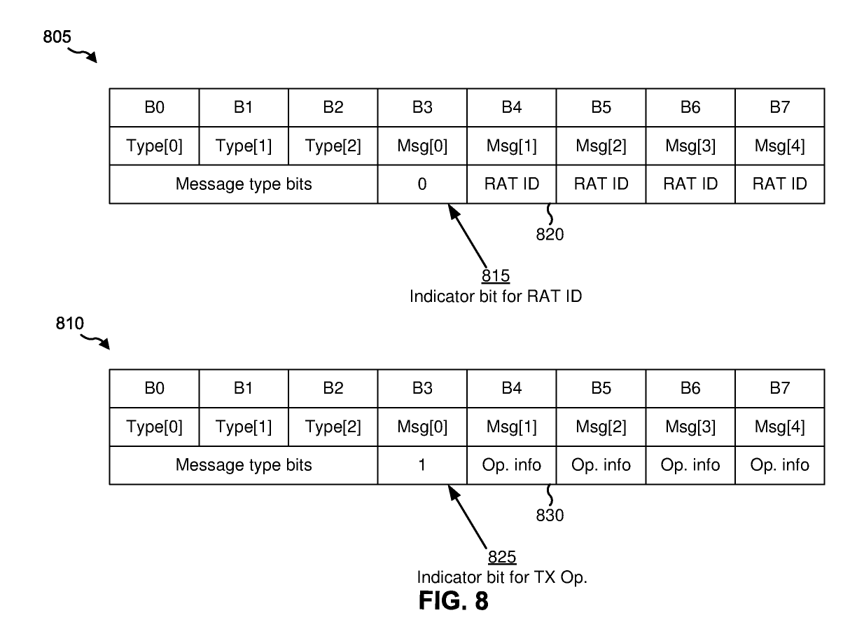

The RAT identifier may be identified in a message portion of the Type-7 message, as described in more detail in connection with FIG. 8, below. Furthermore, the Type-7 message may include a value indicating that the Type-7 message carries the RAT identifier, as also described in more detail in connection with FIG. 8, below.

In some aspects, the RAT identifier may include one or more bits that identify a RAT associated with transmitter component 705. For example, when transmitter component 705 is a WWAN component (e.g., a WWAN modem, WWAN component 510, etc.), the RAT identifier may identify a WWAN RAT (e.g., 4G/LTE, LAA, eLAA, 5G/NR, mm Wave, etc.). When transmitter component 705 is a WLAN component, the RAT identifier may identify a WLAN RAT (e.g., 2.4 GHz WiFi, 5 GHz WiFi, 6 GHz WiFi, Bluetooth, 60 GHz 11ad, etc.). Other examples of RATs that may be identified by the RAT identifier include WLAN 802.11p (e.g., DSRC or Dedicated Short Range Communications), WWAN 4G C-V2x (e.g., Cellular-Vehicle to x), WWAN 5G/NR C-V2x, WWAN 4G C-P2V (e.g., Cellular-Pedestrian to Vehicle), WWAN 5G/NR C-P2V, or any other RAT.

As shown by reference number 725, the transmitter component 705 may provide a Type-7 message that includes information regarding the transmit operation for the particular RAT. For example, the transmitter component 705 may provide the information regarding the transmit operation for the particular RAT in a message portion of the Type-7 message, as described in more detail in connection with FIG. 8, below. In some aspects, the Type-7 messages shown by reference numbers 720 and 725 may have a value that indicates whether the Type-7 messages carry a RAT identifier or transmit information, as described in more detail in connection with FIG. 8.

As shown by reference number 730, the receiver component 710 may process the Type-7 message based at least in part on the RAT identifier. For example, the receiver component 710 may determine the information regarding the transmit operation associated with the particular RAT, and may perform the transmit operation with regard to the particular RAT. The transmit information may include information regarding the transmit operation, such as information identifying a particular RAT for which the transmit operation is to be performed, information identifying a particular band for which the transmit operation is to be performed, information identifying a particular antenna or antennas for which the transmit operation is to be performed, information identifying a length of the transmit operation (e.g., 1 ms, 0.5 ms, 0.25 ms, 0.125 ms, etc.), and/or the like. For a more detailed description of formatting of the transmit message, refer to FIG. 8, below. To perform the transmit operation, the receiver component 710 may cease transmission for one or more antennas, RATs, bands, and/or the like. In this way, the transmitter component 705 signals that a transmit operation is to be performed using a WCI message, such as a Type-7 WCI message, which may improve interoperability of the transmitter component 705 and the receiver component 710.

As used herein, a transmit operation may refer to any operation to be performed by the transmitter component 705, such as an abort operation, a blanking operation, a power decrease operation, and/or the like.

In some aspects, the receiver component 710 may determine information regarding the particular RAT based at least in part on the Type-7 messages, as described in more detail elsewhere herein. In this way, the transmitter component 705 may provide information regarding the particular RAT with an indication that the information is associated with the particular RAT. This may be beneficial for situations in which UE 120 is associated with multiple, different RATs. For example, this may be beneficial when UE 120 includes multiple, different transmitter components 705 corresponding to multiple, different RATs, and/or when UE 120 includes a transmitter component 705 capable of providing information regarding multiple, different RATs. For example, this may be beneficial for UEs 120 associated with a 4G/LTE and 5G/NR deployment.

In some aspects, the receiver component 710 may determine the particular RAT based at least in part on a WCI-2 interface on which the information regarding the particular RAT is received. For example, the receiver component 710 may determine a first RAT when the information regarding the particular RAT is received on a first WCI-2 interface, and may determine a second RAT when the information regarding the particular RAT is received on a second WCI-2 interface. Additionally, or alternatively, the receiver component 710 may determine a first RAT when the information regarding the particular RAT is received from a first transmitter component 705 (e.g., associated with the first RAT), and may determine a second RAT when the information regarding the particular RAT is received from a second transmitter component 705 (e.g., associated with the second RAT).

In some aspects, transmitter component 705 may automatically attach a RAT identifier to a message. For example, when a message is a Type-0 message (e.g., a real-time message), transmitter component 705 may automatically attach a RAT identifier to the message using a general purpose I/O (GPIO) connection, a general radio frequency (RF) connection (GRFC), and/or the like. In some aspects, receiver component 710 may automatically perform an action based at least in part on a RAT identifier. For example, receiver component 710 may automatically forward the information regarding the particular RAT to an appropriate register based at least in part on the RAT identifier.

In some aspects, receiver component 710 may selectively process or not process a message based at least in part on a RAT identifier associated with the message. For example, receiver component 710 may react only to messages associated with a particular RAT identifier. As a more particular example, a receiver component 710 associated with 4G/LTE may process messages associated with a WLAN 2.4 GHz RAT, and a receiver component 710 associated with 5G/NR may process messages associated with a WLAN 5 GHz RAT or a WLAN 6 GHz RAT.

In some aspects, the receiver component 710 may receive a Type-1 message associated with a RAT identifier. In such a case, the receiver component 710 may retransmit a most recently sent Type-0 message or the most recently sent Type-0 message that is associated with the RAT identifier. Additionally, or alternatively, the receiver component 710 may retransmit most recently sent Type-0 messages associated with each active RAT. Additionally, or alternatively, the receiver component 710 may remove or prune frame synchronization information from the retransmission of the Type-0 messages. This may conserve message bandwidth that would otherwise be used for outdated frame synchronization information.

In some aspects, the receiver component 710 may receive a Type-6 transmission advance notification message from the transmitter component 705. For example, the transmitter component 705 (e.g., a transmitter component associated with 4G/LTE) may provide a Type-6 message to the receiver component 710 when a subframe is designated for uplink transmission and the transmitter component 705 will not transmit in any shortened transmission time interval (sTTI) of the subframe. In a k=4 timing regime, wherein grants are received 4 sTTIs before a corresponding transmission is to be performed, the transmitter component 705 may know that no transmission is to be performed in a fifth sTTI by the end of a first sTTI. In such a case, the transmitter component 705 may provide a Type-6 message in or before a third sTTI (e.g., at least 1 ms before the fifth sTTI). For example, the transmitter component 705 may provide the Type-6 message in or before a middle of the third sTTI. In some aspects, the transmitter component 705 may aggregate sTTIs across multiple subframes to determine when to provide a Type-6 message. For example, the transmitter component 705 may determine a 1.5 ms period spanning 3 subframes, may determine a 2 ms period spanning 4 subframes, and/or the like. In such a case, the transmitter component 705 may determine when to provide the Type-6 message based at least in part on a value of k, wherein k is based at least in part on the period.

Example 700 may include additional aspects, such as any single aspect or any combination of aspects described below.

In some aspects, the at least one transmitter component includes a wireless wide area network modem and the at least one receiver component includes a wireless local area network chipset. In some aspects, the at least one transmitter component includes a wireless local area network chipset and the at least one receiver component includes a wireless wide area network modem. In some aspects, a first transmitter component of the at least one transmitter component is associated with a 4G/Long Term Evolution RAT and a second transmitter component of the at least one transmitter component is associated with a 5G/New Radio RAT. In some aspects, a first receiver component of the at least one receiver component is associated with a 2.4 gigahertz WiFi RAT and a second receiver component of the at least one receiver component is associated with a 5 gigahertz WiFi RAT. In some aspects, the plurality of wireless coexistence interfaces comprise wireless coexistence interface 2 (WCI-2) interfaces. In some aspects, the at least one transmitter component is associated with a same vendor as the at least one receiver component.

As indicated above, FIG. 7 is provided merely as an example. Other examples may differ from what is described with regard to FIG. 7.

FIG. 8 is a diagram illustrating an example of a format for a WCI message that indicates a RAT identifier or a transmit operation. Reference number 805 shows a WCI message for a RAT identifier and reference number 810 shows a WCI message for a transmit operation. For example, the WCI message identified by reference number 805 may correspond to the first Type-7 message shown by reference number 720 in FIG. 7, and the WCI message identified by reference number 810 may correspond to the second Type-7 message shown by reference number 725 in FIG. 7. In some aspects, the values shown by reference numbers 805 and 810 may be provided in a single message or communication.

As shown by reference number 815, the WCI message may include an indicator bit. In some aspects, the indicator bit may use a first bit of the message portion of the WCI message, although the indicator bit can use any bit of the message portion. As further shown, the indicator bit is set to a first value (e.g., shown as 0) to indicate that the message carries a RAT identifier. As shown by reference number 820, the RAT identifier may be provided in a remainder of the message portion of the WCI message. In some aspects, the RAT identifier may use four bits of the message portion. This may provide increased flexibility and a larger potential variety of RAT identifiers. In some aspects, the RAT identifier may use fewer than four bits. This may provide one or more bits of the message portion for other uses.

As shown by reference number 825, the indicator bit may be set to a second value (e.g., shown as 1) to indicate that the WCI message carries transmit operation information. As shown by reference number 830, the transmit operation information may be provided in a remainder of the message portion of the WCI message. In some aspects, the transmit message may be associated with a RAT identifier message. For example, a first message may carry a RAT identifier (e.g., associated with a first value of the indicator bit) and a second message may carry transmit operation information associated with a RAT corresponding to the RAT identifier.

In some aspects, the first message shown in FIG. 8 may be a Type-2 or Type-5 message, and the second message shown in FIG. 8 may be any message type. In other words, in some aspects, the message identifying the RAT identifier may be attached to any message type. In some aspects, the message identifying the RAT identifier may be attached to a subset of possible message types.

In some aspects, 1 bit (e.g., MSG[0] or a different bit) may indicate whether the WCI message carries the RAT identifier. In some aspects, 1 bit may represent a RAT identifier for all WWAN RATs. In some aspects, 1 bit may represent one designated or pre-arranged WWAN RAT. In some aspects, 2 bits may represent a RAT identifier for up to 4 WWAN RATs. In some aspects, 2 bits may represent up to 4 different sets of WWAN RATs. In some aspects, 3 bits may represent a RAT identifier for up to 8 WWAN RATs. In some aspects, 3 bits may represent a RAT identifier for up to 8 different sets of WWAN RATs. In some aspects, 4 bits may represent a RAT identifier for up to 16 WWAN RATs. In some aspects, 4 bits may represent up to 16 different sets of WWAN RATs. When using 5 bits (including such as MSG[0]) for a RAT identifier, the 5 bits may represent a RAT identifier for up to 32 WWAN RATs, or may represent a RAT identifier for up to 32 different sets of WWAN RATs. In some aspects, a RAT identifier may be applied for a limited subset of messages. For example, a RAT identifier may be applied for certain message types and may not be applied for other message types.

In some aspects, the Type-7 message may include five bits in a message portion of the Type-7 message. The five bits may carry values relevant to a RAT identified by the RAT identifier (e.g., a WWAN RAT). For example, the Type-7 message may include a first message bit that indicates an RRC connection state associated with the RAT.

In some aspects, the Type-7 message may include information indicating whether a transmission power of the RAT satisfies a threshold. In some aspects, the information indicating whether the transmission power of the RAT satisfies a threshold may occupy multiple bits (e.g., when multiple thresholds are used).

In some aspects, the Type-7 message may include information indicating one or more antennas associated with the RAT. In some aspects, 1 bit (such as MSG[0] or a different bit) may indicate whether the WCI message includes the transmit operation information. In some aspects, 1 bit may represent a transmit operation instruction or information for all WWAN transmitters. In some aspects, 1 bit may represent a transmit operation instruction or information for one designated or pre-arranged WWAN transmitter or set of WWAN transmitters. In some aspects, 2 bits may represent a transmit operation instruction or information for up to 4 WWAN transmitters. In some aspects, 2 bits may represent a transmit operation instruction or information for up to 4 different sets of WWAN transmitters. In some aspects, 3 bits may represent a transmit operation instruction or information for up to 8 WWAN transmitters. In some aspects, 3 bits may represent a transmit operation instruction or information for up to 8 different sets of WWAN transmitters. In some aspects, 4 bits may represent a transmit operation instruction or information for up to 16 WWAN transmitters. In some aspects, 4 bits may represent a transmit operation instruction or information for up to 16 different sets of WWAN transmitters. When using 5 bits (including such as MSG[0]) for a RAT identifier, the 5 bits may represent a transmit operation instruction or information for up to 32 WWAN transmitters, or may represent a RAT identifier for up to 32 different sets of WWAN transmitters.

In some aspects, a message or communication may include a RAT identifier associated with a reserved code. For example, the reserved code may include a sleep or wakeup indicator. A component may transmit the RAT identifier associated with the reserved code when the component is joining a bus based at least in part on ending a sleep mode or leaving a bus based at least in part on beginning a sleep mode. Additionally, or alternatively, the RAT identifier associated with the reserved code may be transmitted with a ping message that is provided based at least in part on (e.g., in response to) a message associated with joining or leaving a bus. In some aspects, a first message or portion of a communication (e.g., message 805) may include a RAT identifier identifying a particular RAT, and a second message or portion of communication (e.g., message 810) may include the reserved code to indicate a sleep or wakeup communication associated with a component for the particular RAT. In some aspects, the message may include any format or type of WCI-2 message described herein, or a combination of two or more WCI-2 messages described herein.

As indicated above, FIG. 8 is provided merely as an example. Other examples may differ from what is described with regard to FIG. 8.

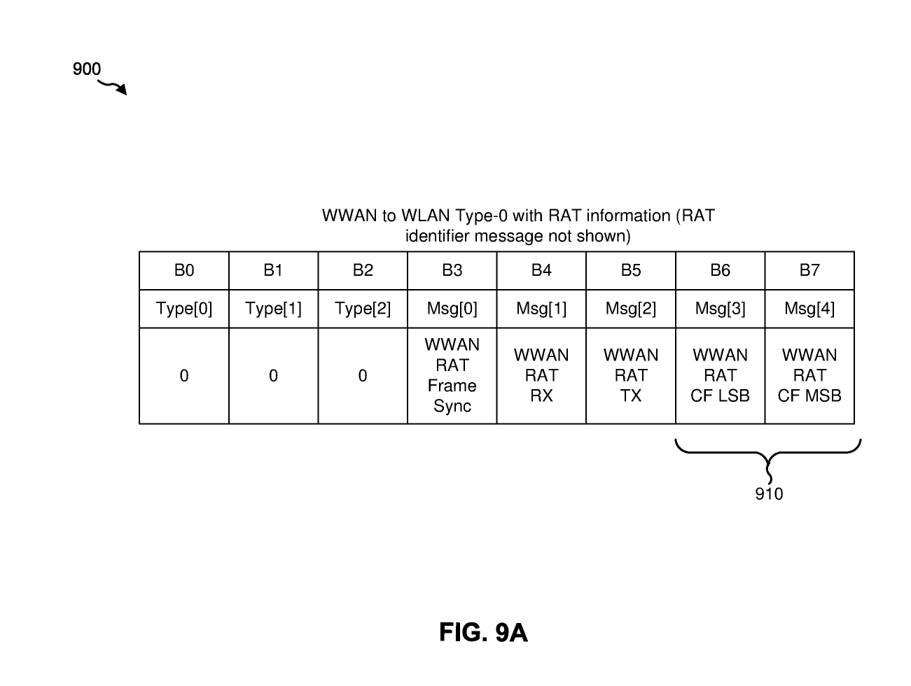

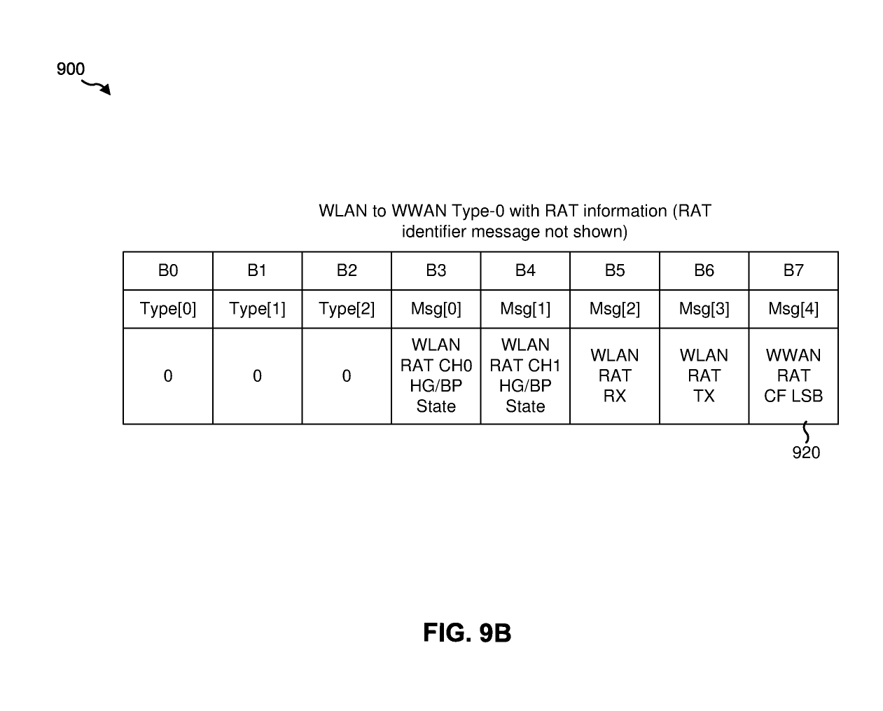

FIGS. 9A and 9B are diagrams illustrating examples 900 of formats for a WCI message including configuration information associated with a particular RAT. FIG. 9A shows an example of a Type-0 message from a WWAN component (e.g., WWAN component 510) to a WLAN component (e.g., WLAN component 520) that may be associated with a RAT identifier. For example, a receiver component (e.g., WLAN component 520) may have previously received a message that includes a RAT identifier (e.g., a Type-5 message and/or the like), and may process the Type-0 message based at least in part on the RAT identifier. Here, the receiver component may determine frame synchronization information for the RAT identifier based at least in part on a first message bit, may determine reception information for the RAT identifier based at least in part on a second message bit, and may determine transmission information for the RAT identifier based at least in part on a third message bit.

As shown by reference number 910, in some aspects, the message may include one or more custom fields (shown as CF). A custom field may be used for any information associated with a RAT identifier, such as information indicating when transmission power of a RAT associated with the RAT identifier satisfies a threshold, information for the WLAN component to adapt a mitigation based at least in part on WWAN transmission power, and/or the like. In some aspects, the custom field may be toggled or set based at least in part on a GPIO, a GRFC, and/or the like. In some aspects, the message may include two bits of custom fields. In some aspects, the message may include a single bit of a custom field. In some aspects, the CFs shown by reference number 910 may be provided in bits reserved for an MWS pattern and/or the like.

FIG. 9B shows an example of a Type-0 message from a WLAN component (e.g., WLAN component 520) to a WWAN component (e.g., WWAN component 510). As shown, the Type-0 message may be associated with a RAT identifier. For example, the WWAN component may have previously received a message (e.g., a Type-2 message, a Type-5 message, etc.) identifying the RAT identifier. As shown, a message portion of the Type-0 message may identify HG/BP states for a first channel (e.g., CH0) and a second channel (e.g., CH1) of a RAT associated with the RAT identifier (e.g., a WLAN RAT, a 5 GHz WLAN RAT, a 6 GHz WLAN RAT, etc.), reception information associated with the RAT, and transmission information associated with the RAT. Furthermore, as shown by reference number 920, the Type-0 message may include a CF, which may include one or more bits. In some aspects, the one or more bits may be associated with a Bluetooth transmit information field and/or the like.

As indicated above, FIGS. 9A and 9B are provided as examples. Other examples may differ from what is described with regard to FIGS. 9A and 9B.

FIG. 10 is a flow chart of a method 1000 of communication. The method may be performed by a transmitter component (e.g., modem 300, the modem shown in FIG. 4, WLAN connectivity module 430, WWAN component 510, WLAN component 520, transmitter component 705, etc.) of a UE (e.g., the UE 120 of FIG. 1 and/or the like).

At 1010, the transmitter component may determine whether first information or second information is to be provided to a receiver component, wherein the first information includes a radio access technology (RAT) identifier and the second information includes information regarding a transmit operation. For example, the transmitter component (e.g., modem core 305, modem processor 310, WWAN component 510, WLAN component 520, etc.) may determine whether first information or second information is to be provided to a receiver component. The first information may include a RAT identifier. The second information may include information regarding a transmit operation. In some aspects, the transmitter component and the receiver component may be associated with the same vendor, such as the same provider, supplier, manufacturer, and/or the like.

At 1020, the transmitter component may transmit a first communication to the receiver component via a wireless coexistence interface between the receiver component and the transmitter component. For example, the transmitter component (e.g., TX FIFO component 345, UART 315, UART module 420, WWAN component 510, WLAN component 520, etc.) may transmit a first communication to the receiver component via a wireless coexistence interface, such as a WCI-2 interface. In some aspects, a particular portion of the communication (e.g., an indicator bit) may be associated with a first value when the first information is to be provided and a second value when the second information is provided. In some aspects, the first communication may include a message such as a WCI message (e.g., a Type-2, Type-5, or Type-7 message).

At 1030, the receiver component (e.g., TX FIFO component 345, UART 315, UART module 420, WWAN component 510, WLAN component 520, etc.) may transmit a second communication, wherein the second communication is to be processed by the receiver component based at least in part on the RAT identifier. In some aspects, the second portion of the communication includes another RAT identifier, wherein the other RAT identifier is associated with a reserved code to indicate a sleep or wakeup communication associated with the RAT identifier. For example, the second communication may include a WCI message, such as a Type-X message, where X is between 0 and 7 (inclusive). In some aspects, the receiver component may determine information associated with a RAT identified by the RAT identifier based at least in part on the second communication. For example, the receiver component may determine that the information is associated with the RAT based at least in part on the information being received in association with the first portion of the communication. In some aspects, the first communication may include the RAT identifier and the second communication may include the transmit operation information.

Method 1000 may include additional aspects, such as any single aspect and/or any combination of aspects described below and/or in connection with one or more other processes described elsewhere herein.

In some aspects, the particular portion comprises a single bit, and the communication includes another portion that indicates the RAT identifier or the information regarding the transmit operation. In some aspects, the communication includes a single byte or a single message. In some aspects, the communication is a Type-2, Type-5, or Type-7 message of a wireless coexistence interface-2 (WCI-2) standard.

In some aspects, the RAT identifier indicates whether a RAT of the receiver component or the transmitter component is one or more of a licensed Long Term Evolution RAT, a license-assisted access RAT, a 5G/New Radio RAT, a millimeter wave RAT, a sub-6 gigahertz RAT, a 2.4 gigahertz local area network RAT, or a 5 gigahertz local area network RAT. In some aspects, the communication includes an indication that a transmission power satisfies one or more thresholds. In some aspects, when the receiver component is a wireless local area network (WLAN) component, the indication is identified by one or more bits associated with a Mobile Wireless Standard (MWS) pattern of the communication.

In some aspects, when the receiver component is a wireless wide area network (WWAN) component, the indication is identified by one or more bits associated with a reserved bit or a Bluetooth transmit bit of the communication. In some aspects, the information regarding the transmit operation identifies at least one transmitter or at least one set of transmitters for which the transmit operation is to be performed, and wherein the information regarding the transmit operation is provided using one or more bits of the communication. In some aspects, the information regarding the transmit operation indicates whether the transmit operation is to be performed for a first wireless local area network transmitter, a second wireless local area network transmitter, or the first wireless local area network transmitter and the second wireless local area network transmitter.

In some aspects, multiple bits of the communication are used to identify multiple RAT identifiers or sets of RAT identifiers. In some aspects, the communication comprises a Type-X message of a wireless coexistence interface-2 (WCI-2) standard, wherein X includes a subset of integers from 0 to 7. In some aspects, the transmitter component may transmit a transmission advance notification, wherein the transmission advance notification is triggered based at least in part on one or more RATs not receiving or transmitting information for multiple, consecutive subframes or slots with a particular duration. In some aspects, the particular duration is greater than or less than 1 millisecond.

Although FIG. 10 shows example blocks of a method of wireless communication, in some aspects, the method may include additional blocks, fewer blocks, different blocks, or differently arranged blocks than those shown in FIG. 10. Additionally, or alternatively, two or more blocks shown in FIG. 10 may be performed in parallel.

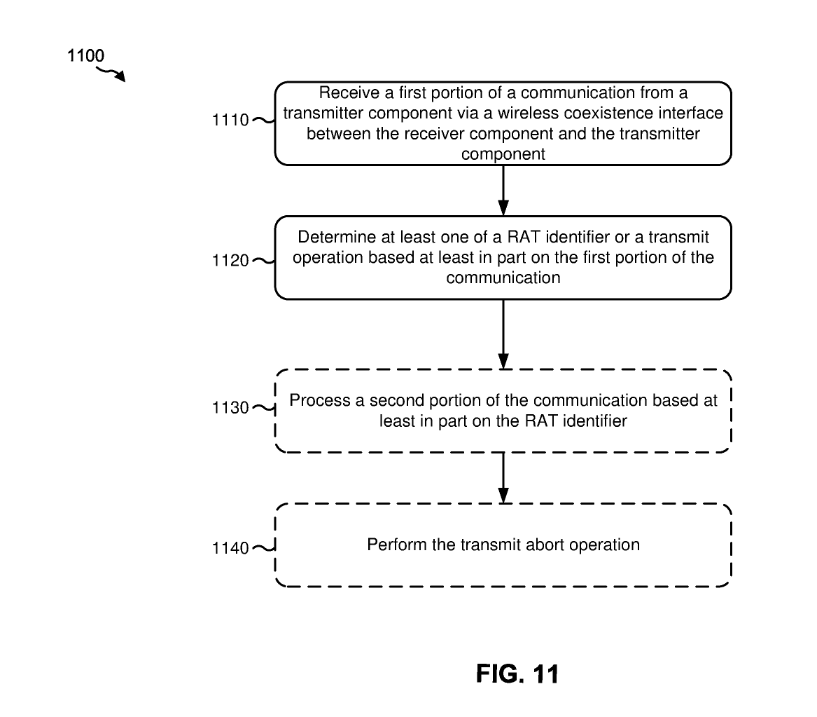

FIG. 11 is a flow chart of a method 1100 of wireless communication. The method may be performed by a receiver component (e.g., modem 300, the modem shown in FIG. 4, WLAN connectivity module 430, WWAN component 510, WLAN component 520, receiver component 710, etc.) of a UE (e.g., the UE 120 of FIG. 1, and/or the like).

At 1110, the receiver component may receive a first portion of a communication from a transmitter component via a wireless coexistence interface between the receiver component and the transmitter component. For example, the receiver component (e.g., UART 315, RX FIFO 350, UART module 420, WWAN component 510, WLAN component 520, etc.) may receive a first portion of a communication from a transmitter component (e.g., modem 300, system 400, WWAN component 510, WLAN component 520, transmitter component 705, etc.). In some aspects, the receiver component may receive the first portion via a WCI interface between the receiver component and the transmitter component. In some aspects, the first portion of the communication may include a WCI message, such as a Type-2 message or a Type-5 message. In some aspects, the receiver component and the transmitter component may be associated with the same vendor, such as the same provider, manufacturer, supplier, and/or the like.

At 1120, the receiver component may determine at least one of a RAT identifier or a transmit operation based at least in part on the first portion of the communication. For example, the receiver component (e.g., modem core 305, modem processor 310, WWAN component 510, WLAN component 520, etc.) may determine a RAT identifier and/or a transmit operation based at least in part on the first portion of the communication. In some aspects, the first portion of the communication may include an indicator bit that indicates whether the first portion includes a RAT identifier or information associated with a transmit operation. In some aspects, the receiver component may determine a transmit operation associated with the RAT identifier. For example, the receiver component may determine to perform a transmit operation with regard to a RAT identified by the RAT identifier.

At 1130, the receiver component (e.g., modem core 305, modem processor 310, WWAN component 510, WLAN component 520, etc.) may process a second portion of the communication based at least in part on the RAT identifier. For example, the second portion of the communication may include a WCI message, such as a Type-X message, where X is between 0 and 7 (inclusive). In some aspects, the receiver component may determine information associated with a RAT identified by the RAT identifier based at least in part on the second portion of the communication. For example, the receiver component may determine that the information is associated with the RAT based at least in part on the information being received in association with the first portion of the communication.

At 1140, the receiver component (e.g., modem core 305, modem processor 310, WWAN component 510, WLAN component 520, etc.) may perform the transmit operation. For example, the receiver component may perform the transmit operation indicated by the first portion of the communication. In some aspects, the receiver component may perform the transmit operation with regard to a RAT identified by a RAT identifier of the first portion of the message. For example, the receiver component may perform the transmit operation based at least in part on the second portion of the communication.

Method 1100 may include additional aspects, such as any single aspect and/or any combination of aspects described below and/or in connection with one or more other processes described elsewhere herein.

In some aspects, the RAT identifier indicates whether a RAT of the receiver component or the transmitter component is one or more of a licensed Long Term Evolution RAT, a license-assisted access RAT, a 5G/New Radio RAT, a millimeter wave RAT, a sub-6 gigahertz RAT, a 2.4 gigahertz local area network RAT, a 6 gigahertz local area network RAT, or a 5 gigahertz local area network RAT. In some aspects, the first portion of the communication or the second portion of the communication includes an indication that a transmission power satisfies one or more thresholds. In some aspects, when the receiver component is a wireless local area network (WLAN) component, the indication is identified by one or more bits associated with a Mobile Wireless Standard (MWS) pattern.

In some aspects, when the receiver component is a wireless wide area network (WWAN) component, the indication is identified by one or more bits associated with a reserved bit or a Bluetooth transmit bit. In some aspects, one or more bits are used to indicate the transmit operation, and the one or more bits indicate at least one transmitter or at least one set of transmitters for which the transmit operation is to be performed.

In some aspects, one or more bits are used to indicate the transmit operation, and the one or more bits indicate whether the transmit operation is to be performed for a first wireless local area network transmitter, a second wireless local area network transmitter, or the first wireless local area network transmitter and the second wireless local area network transmitter.

In some aspects, the first portion of the communication comprises a Type-2, Type-5, or Type-7 message of a wireless coexistence interface-2 (WCI-2) standard, and a bit of the Type-2 or Type-5 message indicates whether the first portion of the communication identifies the RAT identifier or the transmit operation. In some aspects, multiple bits of the first portion of the communication are used to identify multiple RAT identifiers or sets of RAT identifiers. In some aspects, the second portion of the communication comprises a Type-X message of the WCI-2 standard, wherein X is any value other than 2 or 5.

In some aspects, the first portion of the communication is attached to the second portion of the communication. In some aspects, the second portion of the communication comprises a Type-X message of a wireless coexistence interface-2 (WCI-2) standard, wherein X includes a subset of integers from 0 to 7. In some aspects, the receiver component may process the second portion of the communication based at least in part on the RAT identifier and perform the transmit operation. In some aspects, the second portion of the communication includes another RAT identifier, wherein the other RAT identifier is associated with a reserved code to indicate a sleep or wakeup communication associated with the RAT identifier. In some aspects, the first portion of the communication is of a same message type as the second portion of the communication. In some aspects, the receiver component may receive a transmission advance notification in a particular message, wherein the transmission advance notification is triggered based at least in part on one or more RATs not receiving or transmitting for multiple, consecutive subframes or slots with a particular duration. In some aspects, the particular duration is greater than or less than 1 millisecond.

Although FIG. 11 shows example blocks of a method of wireless communication, in some aspects, the method may include additional blocks, fewer blocks, different blocks, or differently arranged blocks than those shown in FIG. 11. Additionally, or alternatively, two or more blocks shown in FIG. 11 may be performed in parallel.

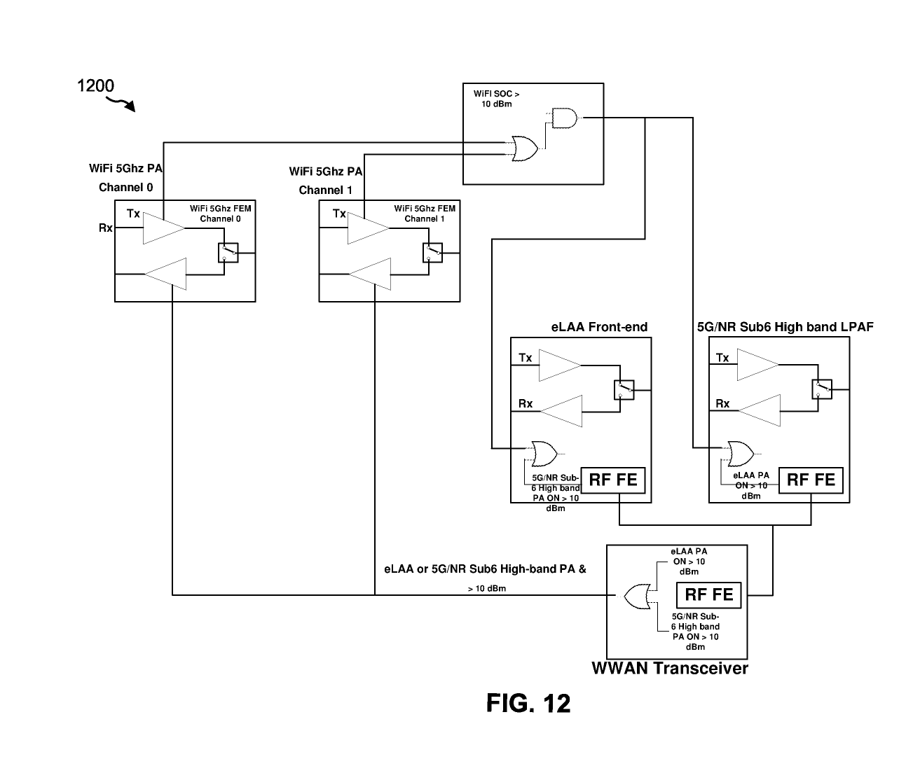

FIG. 12 is a diagram illustrating an example 1200 of a low noise amplifier (LNA) blanking configuration. Example 1200 may relate to a scenario in which LNA blanking is performed based at least in part on a 5 GHz WLAN transmission power satisfying a threshold. Example 1200 may support LNA blanking based at least in part on general purpose I/O (GPIO) or general RF center (GRFC) input. For example, the LNA blanking may be performed based at least in part on a short turnaround time between an end of a WLAN reception and a start of a WLAN transmission, and/or based at least in part on a firmware/software latency to process and/or act on a message (e.g., a Type-0 WCI message) from a WLAN component. In some aspects, example 1300 may include two or more eLAA front-ends and/or two or more 5G/NR sub6 High-band low pass active filters. In some aspects, a 5G/NR sub6 high-band band may be termed an n79 band.

As indicated above, FIG. 12 is provided as an example. Other examples may differ from what is described in connection with FIG. 12.

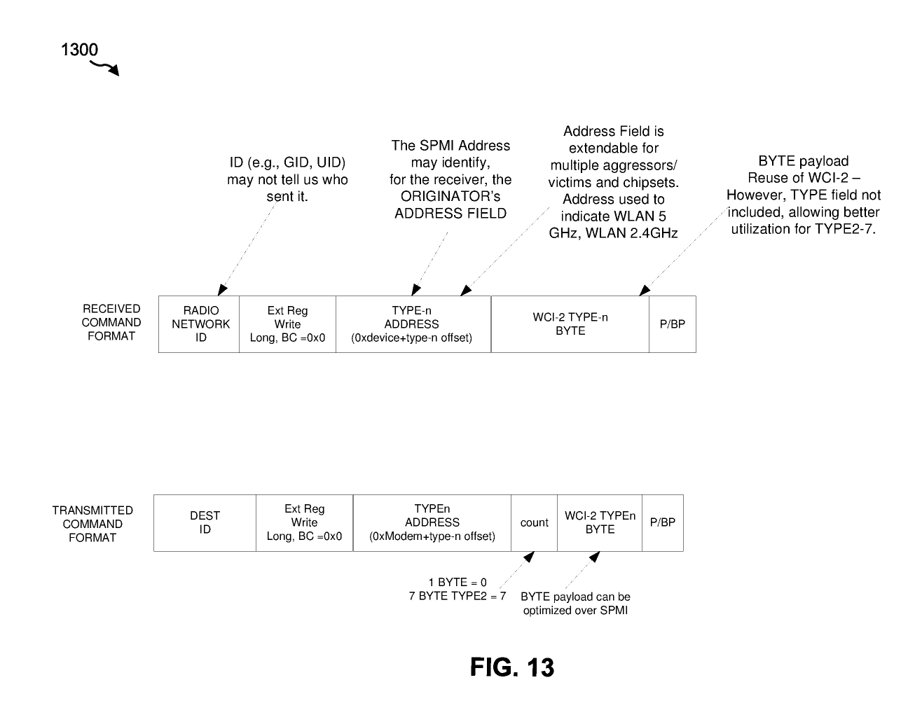

FIG. 13 is a diagram illustrating an example 1300 of a command format for a command associated with a WCI-2 message. Example 1300 may be an example of a system power management interface (SPMI) command and/or long addressing structure. In FIG. 13, 1 SPMI write may contain a single WCI-2 equivalent command. Type-2 messages (described herein) may be set as up to 8 bytes in 1 command. A single write command may contain 1 byte for Type-0, Type-1, and Type-3 through Type-7 messages. An identifier, such as a USID (e.g., unique slave identifier) or another identifier, may identify a destination of the command. An address associated with the command may identify a source of the command. Different components (e.g., modems, WLAN chips, Bluetooth chips, etc.) may use different address ranges. A modem (e.g., that transmits the command) may use the address associated with the WCI-2 message to communicate type information regarding the WCI-2 message. This may provide (e.g., 3) additional bits for information in a payload of the command.

As indicated above, FIG. 13 is provided as an example. Other examples may differ from what is described in connection with FIG. 13.

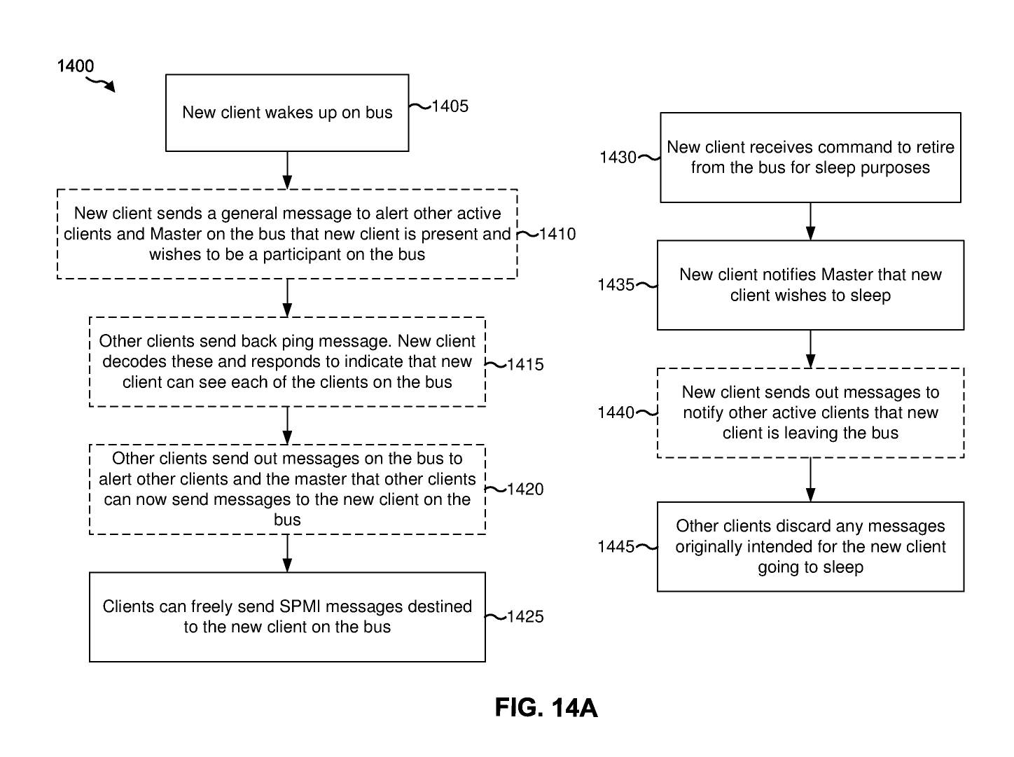

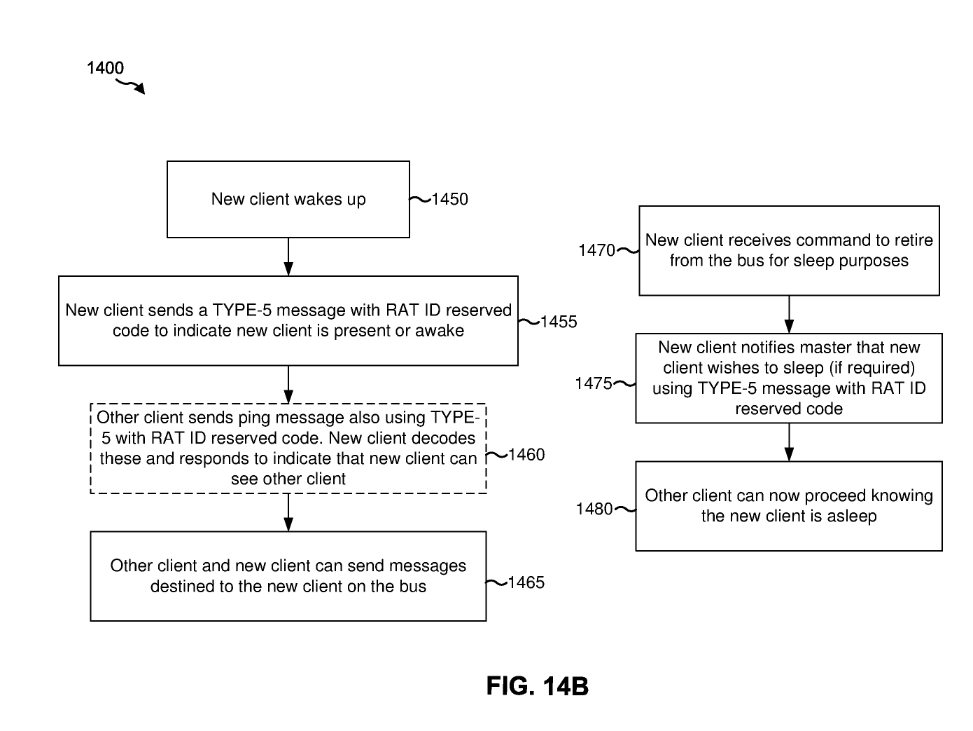

FIGS. 14A and 14B are diagrams illustrating flow charts of methods 1400 associated with signaling for wakeup or sleep of a client, such as a client described herein. In FIGS. 14A and 14B, optional steps may be indicated by dashed boxes.

As shown by reference number 1405, a new client may wake up on a bus. For example, the new client may include one or more of the components described herein (e.g., a WWAN component, a WLAN component, etc.) and the bus may include one or more of the buses described herein. As described herein, waking up may refer to power on, power up into a usable state, exiting a sleep mode, and/or the like.

As shown by reference number 1410, the new client may send a message to alert other active clients and/or a master (e.g., an application processor of UE 120) on the bus that the new client is present and wishes to be a participant on the bus. For example, the new client may provide a message using a particular format and/or including particular information, as described in more detail in connection with FIG. 14B, below. In some aspects, the new client may send the message to the other clients. In some aspects, the new client may send the message to the master (e.g., using a slave to master write and/or the like). In some aspects, the message may be a special message that is reserved to indicate wakeup. For example, the message may not be a general message. In some aspects, a master may update a local register of known clients on the bus, and may inform the other clients of the presence of the new client.

As shown by reference number 1415, the new client may receive one or more ping messages from one or more other clients on the bus (e.g., the other active clients). The new client may decode the ping messages, and may respond to indicate that the new client can see each of the other clients on the bus. In some aspects, the operation shown by reference number 1415 may be performed optionally (e.g., if the new client transmits a broadcast write, or after the application processor has processed the message or request).

As shown by reference number 1420, the other clients may send out messages on the bus to indicate (e.g., alert) to other clients and/or the master that the other clients can send messages to the new client on the bus. As shown by reference number 1425, at this point, the other clients can freely send messages (e.g., system power management interface (SPMI)) messages destined to the new client on the bus.

Reference numbers 1430-1445 refer to a case wherein the new client (or any active client) performs messaging to enter a sleep mode.

As shown by reference number 1430, the new client may receive a command to retire from the bus for sleep purposes. In some aspects, the new client may determine that the new client is to enter a sleep mode.

As shown by reference number 1435, the new client may notify a master (e.g., using a message, such as a slave to master write) that the new client wishes to sleep. As shown by reference number 1440, the new client may send messages to notify the other active clients that the new client is leaving the bus (e.g., entering the sleep mode). As shown by reference number 1445, the other clients may discard a message originally intended for the new client (e.g., based at least in part on the message indicating that the active client is going to sleep or leaving the bus).

FIG. 14B shows an example using messaging formats that may be associated with WCI-2, such as the Type-5 messaging format described herein. As shown by reference number 1450, a new client may wake up, as described in more detail in connection with reference number 1405, above. As shown by reference number 1455, the new client may send a Type-5 message with a RAT ID reserved code to indicate that the new client is present or awake. For example, the RAT ID reserved code may include a RAT identifier that is not associated with an active RAT, and that is configured to indicate that the new client is present or awake.

As shown by reference number 1460, another client may send a ping message to the new client based at least in part on the Type-5 message. For example, the ping message may also include a Type-5 message with a RAT identifier that is not associated with an active RAT. The RAT identifier used in the ping message may indicate that the ping message is associated with the message from the new client, may indicate that the ping message relates to sleep or wakeup signaling, and/or the like. As further shown, the new client may decode the ping message, and may transmit a message, based at least in part on the ping message, to indicate that the new client can see the other client (e.g., has received the ping message). As shown by reference number 1465, the other client and the new client can, at this point, send messages (e.g., freely) that are destined to the new client on the bus.

As shown by reference number 1470, the new client may receive a command to retire from the bus for sleep purposes. In some aspects, the new client may determine that the new client is to enter a sleep state, to shut down, to retire from the bus, and/or the like. As shown by reference number 1475, the new client may notify a master on the bus (e.g., an application processor and/or the like) that the new client wishes to sleep. For example, the new client may notify the master if such a message is required. As further shown, the new client may notify the master using a Type-5 message with the RAT ID reserved code, as described in more detail elsewhere herein. As shown by reference number 1480, the other client can now proceed knowing that the new client is asleep.

As indicated above, FIGS. 14A and 14B are provided as examples. Other examples may differ from what is described with regard to FIGS. 14A and 14B.

The techniques and apparatuses described herein are not limited to those in which a first WCI-2 message is transmitted separately from a second WCI-2 message. In some aspects, a first message and a second message, as described herein, may be two portions of a single message or communication. For example, when using SPMI or RF front-end (RFFE), a single command may be used to provide the information described elsewhere herein as being provided in two or more messages. Furthermore, the techniques and apparatuses described herein are not limited to those wherein a particular RAT identifier is used to indicate wakeup, sleep, and/or the like. For example, a message may include other information indicating that a client is to wake up, sleep, leave the bus, and/or the like. For example, the other information may include or be associated with a dedicated address or register for each client that corresponds to the sleep/wakeup command (e.g., for SPMI).

It is understood that the specific order or hierarchy of blocks in the processes/flow charts disclosed is an illustration of example approaches. Based upon design preferences, it is understood that the specific order or hierarchy of blocks in the processes/flow charts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of communication performed by a transmitter component, comprising:
determining whether first information or second information is to be provided to a receiver component, wherein the first information includes a radio access technology (RAT) identifier and the second information includes information regarding a transmit operation; and
transmitting a communication to the receiver component via a wireless coexistence interface between the receiver component and the transmitter component,
wherein a particular portion of the communication is associated with a first value when the first information is to be provided, and wherein the particular portion is associated with a second value when the second information is to be provided.

2. The method of claim 1, wherein the particular portion comprises a single bit, and wherein the communication includes another portion that indicates the RAT identifier or the information regarding the transmit operation.

3. The method of claim 2, wherein the communication includes a single byte or a single message.

4. The method of claim 1, wherein the communication is a Type-2, Type-5, or Type-7 message of a wireless coexistence interface-2 (WCI-2) standard.

5. The method of claim 1, wherein the information regarding the transmit operation identifies at least one transmitter or at least one set of transmitters for which the transmit operation is to be performed, and wherein the information regarding the transmit operation is provided using one or more bits of the communication.

6. The method of claim 1, wherein the information regarding the transmit operation indicates whether the transmit operation is to be performed for a first wireless local area network transmitter, a second wireless local area network transmitter, or the first wireless local area network transmitter and the second wireless local area network transmitter.

7. The method of claim 1, wherein multiple bits of the communication are used to identify multiple RAT identifiers or sets of RAT identifiers.

8. The method of claim 1, wherein the communication comprises a Type-X message of a wireless coexistence interface-2 (WCI-2) standard, wherein X includes a subset of integers from 0 to 7.

9. The method of claim 1, further comprising:
transmitting a transmission advance notification, wherein the transmission advance notification is triggered based at least in part on one or more RATs not receiving or transmitting information for multiple, consecutive subframes or slots with a particular duration.

10. The method of claim 1, wherein the communication is a first communication, and wherein the method further comprises:
transmitting a second communication, wherein the second communication is to be processed by the receiver component based at least in part on the RAT identifier.

11. The method of claim 10, wherein the second communication includes another RAT identifier, wherein the another RAT identifier is associated with a reserved code to indicate a sleep or wakeup communication associated with the RAT identifier.

12. A system, comprising:
at least one transmitter component;
at least one receiver component; and
a plurality of wireless coexistence interfaces between the at least one transmitter component and the at least one receiver component,
the at least one transmitter component configured to:
determine whether first information or second information is to be provided to the at least one receiver component, wherein the first information includes a radio access technology (RAT) identifier and the second information includes information regarding a transmit operation; and
transmit a communication to the at least one receiver component via a wireless coexistence interface of the plurality of wireless coexistence interfaces,
wherein a particular portion of the communication is associated with a first value when the first information is to be provided, and wherein the particular portion is associated with a second value when the second information is to be provided.

13. The system of claim 12, wherein a first transmitter component of the at least one transmitter component is associated with a 4G/Long Term Evolution RAT and a second transmitter component of the at least one transmitter component is associated with a 5G/New Radio RAT.

14. The system of claim 12, wherein a first receiver component of the at least one receiver component is associated with a 2.4 gigahertz WiFi RAT and a second receiver component of the at least one receiver component is associated with a 5 gigahertz WiFi RAT.

15. The system of claim 12, wherein the at least one transmitter component is associated with a same vendor as the at least one receiver component.

16. A method of communication performed by a receiver component, comprising:
receiving a first portion of a communication from a transmitter component via a wireless coexistence interface between the receiver component and the transmitter component;
determining at least one of a radio access technology (RAT) identifier or a transmit operation based at least in part on the first portion of the communication; and
at least one of:
processing a second portion of the communication based at least in part on the RAT identifier; or
performing the transmit operation.

17. The method of claim 16, wherein the receiver component is associated with a same vendor as the transmitter component.

18. The method of claim 16, wherein one or more bits are used to indicate the transmit operation, and wherein the one or more bits indicate at least one transmitter or at least one set of transmitters for which the transmit operation is to be performed.

19. The method of claim 16, wherein one or more bits are used to indicate the transmit operation, and wherein the one or more bits indicate whether the transmit operation is to be performed for a first wireless local area network transmitter, a second wireless local area network transmitter, or the first wireless local area network transmitter and the second wireless local area network transmitter.

20. The method of claim 16, wherein the first portion of the communication comprises a Type-2, Type-5, or Type-7 message of a wireless coexistence interface-2 (WCI-2) standard, and wherein a bit of the Type-2, Type-5, or Type-7 message indicates whether the first portion of the communication identifies the RAT identifier or the transmit operation.

21. The method of claim 20, wherein multiple bits of the first portion of the communication are used to identify multiple RAT identifiers or sets of RAT identifiers.

22. The method of claim 20, wherein the second portion of the communication comprises a Type-X message of the WCI-2 standard, wherein X is any value other than 2 or 5.

23. The method of claim 16, wherein the first portion of the communication is attached to the second portion of the communication.

24. The method of claim 16, further comprising:
processing the second portion of the communication based at least in part on the RAT identifier; and
performing the transmit operation.

25. The method of claim 16, wherein the first portion of the communication is of a same message type as the second portion of the communication.

26. The method of claim 16, further comprising:
receiving a transmission advance notification in a particular message, wherein the transmission advance notification is triggered based at least in part on one or more RATs not receiving or transmitting for multiple, consecutive subframes or slots with a particular duration.

27. A method of wireless communication performed by a client, comprising:
providing a communication to at least one another client or a master via a bus, wherein the communication is to indicate a sleep or wakeup of the client based at least in part on an identifier that is associated with a reserved code to indicate that the communication indicates the sleep or wakeup; and
communicating with the at least one another client or the master via the bus based at least in part on the communication.

28. The method of claim 27, further comprising:
receiving a message based at least in part on the communication,
wherein the message includes the identifier that is associated with the reserved code; and
providing a response to the message based at least in part on the identifier that is associated with the reserved code.

29. The method of claim 27, further comprising:
receiving a command to retire from the bus to sleep; and
transmitting a message including the identifier that is associated with the reserved code to indicate that the client is to retire from the bus to sleep.

30. The method of claim 27, wherein the client, the at least one another client, and the master communicate based at least in part on at least one of a system power management interface protocol, a radio frequency front end protocol, or a wireless coexistence interface-2 protocol.
